(19) United States
(12) Patent Application Publication
(10) Pub. No.: US 2010/0092912 A1
(43) Pub. Date: Apr. 15, 2010

(54) GUIDE TUBE AND GUIDE TUBE POSITIONING DEVICE

(76) Inventors: Asbel Rodrigues Machado, Uberlandia (BR); Eder Ferreira Rangel, Uberlandia (BR); Keuler Ferreira Rangel, Uberlandia (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/248,354

(22) Filed: Oct. 9, 2008

(51) Int. Cl. A61C 3/02

(52) U.S. Cl. 433/76

(57) ABSTRACT

A guide tube to enable the boring of orifices in the bone portion of the maxilla or jawbone of a patient, including at least a first outer tube segment having a first axial through aperture and at least a second inner tube segment having at least a free end and a second axial through aperture, the second tube segment being inserted inside the first axial through aperture of the first tube segment, and wherein an integrated axial prolongation projects from the free end of the inner tube segment.

### CROSS-REFERENCE TO RELATED APPLICATION

The present application is related to U.S. patent application Ser. No. 11/______ (“the '______ Application”), filed on the same day as the present application, entitled “A Reference Support for a Dental Implant, a Radiographic and/or Tomographic Reference Support Mounting Frame, and a Prosthetic Crown Sounding Guide”, the entire disclosure of which is incorporated herein by reference.

### BACKGROUND OF THE INVENTION

The present invention relates to a guide tube, particularly suited to enable the correct drilling of the alveolar bone of a patient's mouth, facilitating the precise positioning of a dental implant.

The present invention also relates to a guide tube positioning device that enables the positioning of the guide tube with millimetric precision on a plate which is fixed firmly and precisely on the dental arcade of the patient.

The joint operation of the aforementioned guide tube and positioning device enables the alveolar bone of the patient's mouth to be drilled with extreme precision, facilitating the construction and subsequent placement of the prosthetic crown. In fact, this operation corresponds to a positioning process of an implant and, consequently, of the prosthetic crown, carried out in an extremely simple, safe, and, above all, much more precise way that processes currently known.

Guide tubes and their respective positioners are elements used by dental surgeons to place dental implants, a surgical procedure that requires a series of stages and procedural steps so that the implant is correctly and firmly positioned in its site.

The dental implant is an element fixed to the bone portion of the maxilla or jawbone of the patient, which enables the fixing of a prosthetic crown (a ‘synthetic tooth’) in the site where a natural tooth was originally positioned.

For the implant to the fixed correctly, the bone portion has to be drilled in the most suitable site. This orifice receives the implant, which rapidly interacts with the bone tissue and becomes correctly fixed (osseointegration).

The procedure of boring the bone portion of the patient has to be well studied, since boring the orifice at an unsuitable site may prejudice the result of the implant both from an aesthetic point of view and sometimes from a functional point of view, if the fixing is made more difficult due to the incorrect position of the orifice.

For implants applied to the lower alveolar bone jawbone), there is the aggravating factor of the presence of the nervous tissue (lower alveolar nerve) in an internal cavity that passes through the bone, so it is essential to consider this situation when carrying out an implant procedure. Hitting or injuring the nerve will cause the partial paralysis in the face of the patient which is untreatable, so the paralysis becomes a permanent sequela.

If the implant is carried out in the upper alveolar bone (maxilla), there is no major nervous termination, but instead just above is the maxillary sinus and the floor of the nasal cavity, which cannot be perforated otherwise the patient will suffer severe hemorrhaging. When these areas are perforated, it is generally necessary to position the implant in another orifice. However, if the first orifice was already positioned correctly, the final positioning of the implant may be prejudiced.

Therefore, a study of the correct site for boring the orifice must take into account a number of variables, such as the bone constitution of the patient, the shape and positioning of the implant, potential bone loss resulting from inappropriate mouth hygiene, positioning of the lower alveolar nerve, maxillary sinus and nasal cavity floor, among others.

To carry out such a study, the uses professional clinical and image examinations, such as tomographies and radiographies, which provide an effective view of the bone constitution of the patient's face.

A large percentage of dental surgeons carry out tomographic and/or radiographic procedures to obtain the images only to detect the bone constitution of the patient at the site where the implant will be fixed. Unfortunately, in this situation the professional does not perform a more accurate study of the correct positioning of the implant and bores the patient based on his feeling and professional experience. Conventionally, this type of procedure is referred to as free-hand surgery.

Consequently, the free-hand implant rarely achieves the most optimized position, such that the prosthetic crown has to be constituted in a way that compensates for the disalignment of the implant. In the event of minor disalignments, such a situation may not be a problem, but for more considerable disalignments (about 1 millimeter or above), the crown may be compromised in terms of aesthetics or structural resistance.

Another risk in free-hand operations is that the bur or drill used by the dentist may strike the maxillary sinus, the nasal cavity floor, neighboring tooth roots or, worse still, the lower alveolar nerve, which may cause severe consequences for the patient.

To minimize this risk, the professional is generally over cautious with the depth of the orifices drilled, and it is not rare to see implants fixed with little depth. Such implants will certainly have a decreased durability and will have a greater risk of loosening, which is highly inconvenient.

In free-hand surgery, the only way of getting to know the true bone anatomy where the implant will be positioned is by ‘in loco’ visualization—a lengthy procedure that considerably injures the gum tissue, positioned over the bone. ‘In loco’ visualization is achieved by carrying out various incisions in the gum tissue, so that it can be drawn back in order to visualize the bone. After visualizing the bone, the professional has an idea of the position where the bone hole should be drilled and, after placing the implants, he repositions the gum tissue, stitching it up afterwards.

It is obvious that a major lesion to which the gum tissue falls victim causes pain and swelling for the patient, which is the victim of a painful post-operatory process, requiring a great deal of analgesic, anti-inflammatory and antibiotic medicines.

Lastly, a major disadvantage of free-hand surgery lies in the long learning curve of the surgeon, who needs to carry out many surgeries until he/she acquires sufficient experience to minimize positioning errors. However, this learning curve is usually at the cost of more or less serious errors committed in the mouth of patients.

With a view to solve the innumerous drawbacks of free-hand surgery, various techniques have been developed to determine with precision the positioning of the hole to be bored into the bone portion of the patient for the positioning of the implant. In essence, the techniques can be divided into computer-guided surgeries (surgical navigation), by prototyping or based on plaster models.

Computer-guided surgeries (surgical navigation) use sophisticated and complex positioning and visualization electronic equipment in order to obtain the correct positioning of the orifice.

Firstly, tomographic examinations are made of the patient's face, providing a series of images on the shape and bone constitution of the site where the orifice will be bored. Once this information has been obtained, the ideal positioning for boring the orifice is achieved by using a software specific to each equipment. The information on these positioning are fed into the equipment and various sensors are positioned inside and outside the patient's mouth.

During surgery, the professional handles the bur facing a monitor, where he can watch his work. In conjunction with the image of the patient's mouth, the professional is able to note information on the positioning of the orifice being bored. Such positioning is achieved by the interaction of the tool with the various sensors installed inside and outside the patient.

Once the tool positioning information has been established, the equipment compares it to the information on the ideal positioning of the orifice. If the tool positioning strays from the ideally determined positioning, the equipment informs the professional of this divergence on the computer screen by means of light and/or sound signals.

Although the objective of this system is to ensure the positioning of the orifice with great precision, it has a series of drawbacks, as mentioned ahead.

Firstly, the equipment involved is highly complex, meaning high expenditures to acquire, operate and maintain it.

Secondly, there is a need for highly specialized personnel to operate it.

Yet the major drawback of this process lies in the fact that however precise the positioning control of the sensor-guaranteed tool is, it is unable to guarantee the precision of the boring, since the surgeon drills the bone directly without a fixed template that prevents involuntary cross movement of the drill/bur. However firmly he tries to grip the bur, since the tool is loose, divergence is inevitable. Sometimes, a simple variation in the slant of the tool during boring is sufficient to deform the hole and alter its positioning, negatively affecting the accuracy of the work.

In short, the technology of computer-guided implant surgery has high costs and does not guarantee millimetric precision.

As an example of a company that has developed such a system as that described above, Denx®, among others, can be cited.

Surgery using guides obtained by the prototyping process has also been developed to guarantee the correct positioning of the orifice to fix the implant, with millimetric precision.

Usually, the professional makes the first tomographic examination on the face of the patient requiring an implant. Next, a second tomography is taken of a replica of the prosthetic planning containing radiopaque markers. This second tomography is essential due to certain characteristics of this kind of examination.

If the patient has any kind of metal in his mouth (fillings, other implants, etc.), the result of the tomographic examination is altered in the places where the metal is located, generating distortions in the image. In such cases, overlapping this examination with the tomography of the prosthetic planning replica containing radiopaque markers, not only allows the gums to be visualized, but also provides a clear image of the places (teeth) where metallic elements are present.

In the first place, the tomographic examination in the patient reveals the bone portion only, and does not enable a measurement of the gum diameter, mean a second tomographic examination is needed of the prosthetic planning replica containing radiopaque markers. Overlapping the two examinations through the radiopaque markers allows the thickness of the gums and the dimensions of the bones to be appraised, which will enable the correct positioning of the implant.

As a first drawback, the need to perform two tomography examinations (of the patient's face and of the prosthetic planning replica containing radiopaque markers) makes the process more expensive.

Having obtained the information on the bone at the site of the implant, the professional is able to plan the implant correctly, that is, he can determine the ideal diameter and depth of the orifice to be bored, and also determine its ideal position in the bone. This positioning is carried out by a software specific to each equipment.

Having obtained the information on the ideal positioning of the orifice calculated by the professional in the software, a plate made of polymeric material is made in a prototyping equipment (widely known for use in other areas of knowledge, such as engineering and medicine).

This plate obtained already contains the shape of the patient's mouth (teeth, gums, etc., fitting perfectly therein) and comprises a correctly positioned drilling, that is, a hollow tubular metallic guide positioned on the orifice, so as to ensure firmness to the drill/bur as it bores through.

Thereafter, the professional positions the plate over the mouth of the patient, clasping it to the teeth/gums and positions a bur or drill inside the guide. As the guide is in the correct position, theoretically the bone orifice is bored with precision.

However, certain problems are associated to using the guide, which alone cannot guarantee the desired precision of the boring. Although more precise that free-hand drilling, the fact is that when the boring end of the drill passes through the guide, it tends to divert or bend while it sustains the load of having to bore the bone, and such diversion or bending are increased, the greater the free portion of the drill which passed through the guide, and the higher the bone density of the patient. As a result of this characteristic, let it be reiterated, the guide alone does not guarantee the necessary precision of the bone orifice.

Studies published in magazines specialized in odontology highlight the difference between the planned positioning and the obtained in all patients.

Although various variations of this system have been devised, all such variations bear the same concept as that commented upon above.

Another major drawing in using guides obtained by prototyping is the fact that since the equipment is very expensive, few equipment is available, which considerably increase the costs of obtaining this type of guide. Additionally, the time the dental surgeon waits to receive the guide is rather long (3 to 5 weeks on average).

Examples of companies who have developed such systems include Materialise® and Bioparts®, among others.

Finally, guided surgeries based on plaster models can be performed based on radiographic and/or tomographic images.

In using tomographic images, the professional (i) makes the mold of the patient's dental arcade, (ii) makes the plaster models, (iii) fixes the artificial teeth in the region where he intends to install the implants (iv), produces a replica of the plaster models with the artificial teeth, (v) produce a plate made of radiolucent material on the plaster models, (vi) inserts in this plate radiopaque markers specific to each kind of equipment, (vii), inserts radiopaque material (for example barium sulfate) in the cavities formed by the artificial teeth that were previously inserted into the model, thus obtain the tomographic guide, (viii) installs the tomographic guide in the arcade of the patient and finally (ix) performs the tomographic examination on the face of the patient in whom the implant will be placed.

With the results of the examinations, the professional is able to use the software to calculate the correct positioning of the orifice in the bone, always viewing the maximum anchorage of the implant and causing no harm to the patient.

After determining the ideal position of the implant, the professional positions the plaster models in an item of equipment whose base slants in any direction on the horizontal plane and, in some cases, moves linearly horizontally.

Next, the base is positioned with a slant such that a positioning element touches the plaster models in the ideal position (correct horizontal and slant coordinates) to bore the orifice. Thereafter, the positioning element is substituted by a drill or bur and an orifice similar to the one to be made in the mouth of the patient in positioning, angle and depth, is bored.

After boring the orifice, the professional positions in its interior a component similar to the implant (implant analog) to be placed. In some variations of the process, part of the site where the implant will be positioned is removed from the mold, but this is irrelevant for the exact definition of the technique.

Having placed the component similar to the implant, the professional fixes thereon a projecting guide that projects beyond the implant, assuming the central positioning of the site where the original tooth was located. As could be no different, this projecting guide is a mark indicating the ideal spot for positioning the drill for boring.

Thereafter, the professional produces a polymeric plate on top of the plaster models, which, evidently, will contour said projecting guide, and lastly it is suffice to remove the plate and perforate the exact site where the definitive drill guide should be positioned. An alternative is that the projecting guide itself is in fact a drill guide and is an integral part of the plate. In any case, the resulting acrylic plate will have an orifice with a guide in the exact spot where the patient's bone should be drilled.

In the surgical procedure itself, the professional positions a plate on the patient's mouth, clasping it on the teeth/gums and positions a bur or drill inside the guide.

However, once again there appears problems associated to using the guide, which in itself cannot guarantee the desired precision of the drilling. Although it is more precise than free-hand drilling, the fact is that the boring end of the drill, after passing through the guide, tends to divert or bend while it sustains the loading of drilling the bone, and said diversion or bending increases to the extent that the free portion of the drill passing through the guide is higher and the greater the bone density of the patient. As a result of this characteristic, let it be reiterated, the guide alone does not guarantee the precision needed to bore the bone orifice.

Another drawback resides in the excessive steps needed until the orifice is bored, such as the positioning of the model, drilling of the model, insertion of the projecting guide, etc. The positioning of the plaster mold in the correct position requires a series of movements in the positioning equipment (many settings), which brings with it an inherent inaccuracy: the greater the quantity of measurements and steps, the higher the chance that some measurement or positioning error occurs, however minor it may be. And this accumulation of minor errors may cause a final error that is not so irrelevant, which in practice occurs rather frequently.

Such situation, in combination with the inherent inaccuracy of the drilling due to the diversion or bending of the drill/bur, makes the final imprecision of the positioning of the implant, though lower than that of free-hand surgery, still has greater amounts than desirable.

Although diverse variations of these system have been devised, all the variations present the same concept as the one commented upon above. Examples of this kind of system that can be cited include Ray Set (Biaggini), TC Max (Ranali), MED 3D, and Implant Logic System, among others.

It is also worth while noting that although guided surgeries are essentially based on tomography examinations, there are certain variations of the guide-surgery process based on plaster models that supposedly enable the procedure to be carried out based on common radiography examinations, combined with complementary detection examinations (generally gum drilling).

In using radiographic images, the professional comes across certain limitations that are inherent to this technique, namely: (i) the radiography produces bidimensional images (height and width), not permitting the visualization of the third dimension, that is, the thickness of the bone rim, (ii) the images may present a greater or less degree of elongation or shortening depending on the technical expertise of the x-ray operator, and (iii) invariably present some degree of magnification (image amplification). So, to complement this information, and manage to obtain the visualization of the third dimension, that is, the thickness of the bone rim where it is desirable to place the implant, the gum drilling examination is carried out.

Generally, this drilling is carried out by successively perforating the gums, on that site, enabling a mapping of the transversal section of the bone (thickness). Having ascertained the values of the depth of the gums at each point, the professional is able to draw up an estimated profile of the contours with reasonable precision. The next step in this mapping procedure is generally to perforate the acrylic plate, creating a plurality of small orifices that enables said drilling.

However, there is no guarantee that the puncturing used to perforate the gums will penetrate it perpendicularly and, if this does not occur, the depth value will not correspond to the relative thickness of the gums, and accordingly the mapping will be inaccurate.

In any case, after carrying out the drilling, the ideal positioning of the implant can be calculated with regards its horizontal and angle positioning, although it is not possible to estimate the depth of the bone drilling accurately, due to the inherent limitations of the radiography technique, described above.

As mentioned above, one of the factors for inaccuracy of the guided surgery procedures, be it by surgical navigator, prototyping or by plaster models resides in the lack of firmness conferred by the guide tubes, which allows diversion or bending of the drill or bur when boring the bone tissue, not to mention the inaccuracy of the positioning devices due to the multiple settings required.

Currently, various configurations of guide tubes and positioning devices are known in the art, but each presents a certain drawback or limitation, be it of a technical or financial nature, limiting the large scale use thereof.

The Brazilian patent document PI 0301843-1, for example, refers to a constructive arrangement applied to a tube for surgical guide, where the tube comprises a first outer tube and a second inner tube having an upper flange. The second tube, which comprises a through aperture, is fitted inside the first tube and, joined together, form a single device.

By way of the through aperture of the second tube, a plurality of burs or drills is consecutively inserted and perforates the bone tissue of the patient until the final orifice is achieved. By substituting the second tubes for others having through apertures with ever larger diameters, it is possible to position burs with ever larger diameters, which will gradually widen the hole made in the bone tissue of the patient until its final configuration is achieved.

The object of this document presents the drawback in that due to the reduced dimensions of the guide tube, the handling thereof is rather difficult and the inner tube may end up turning jointly with the bur, constituting a dangerous situation and one that delays the conclusion of the procedure. Additionally, it may happen that the patient involuntary ends up ingesting or inhaling the element, which is dangerous.

Finally, the guide tube that is the object of document PI 0301843-1 does not avoid diversion or bending of the drill when boring the bone tissue, not guaranteeing a maximum precision in boring the orifices to place implants.

Regarding positioning devices, which may or may not also contribute to the correct positioning of the implant with great precision, a plurality of devices were proposed, each seeking to solve the problem of the correct positioning to perform the drilling and assembly of the implant guide, yet, as a general rule, they are decidedly complex, expensive, heavy and hard to handle.

The state of the art of positioning devices is well represented by document U.S. Pat. No. 6,634,883, which reveals a positioner having a rigid base, a column projecting from this base and that supports a main head. The column has mechanisms that enable the regulation of the height of the head.

In turn, the head comprises two main portions angularly moveable that comprise locking mechanisms in the most diverse positions and visual indicators of angle position (angle in relation to a given vertical or horizontal reference). One of the two main portions also comprises means (preferably threaded) to fix the positioning guide.

The equipment that is the object of the document U.S. Pat. No. 6,634,883 presents higher costs, dimensions and weight and a relative complexity (many settings) in relation to the support device that is the object of the present invention.

Another conceptually similar known positioner, already mentioned previously, uses a fixed guide in an “L” shaped rod or similar and a base having a movement capacity (slant) in any direction on the horizontal plane and also linear horizontal movement.

As soon as the plaster models are positioned on the base, the base is positioned with a slant such that a positioning element touches the plaster mold in the ideal position (correct horizontal and slant coordinates) to bore the orifice. Thereafter, the positioning element is substituted by a drill or bur in a drill attachable to the device to bore the orifice in the plaster models.

All the kinds of surgery commented upon above, to a greater or lesser extent, present inaccuracy in the positioning of the dental implant, which makes it difficult to create and subsequent position the prosthetic crown.

If the positioning of the implant is overly wrong, the consequent difficulties of making a suitable and functional prosthetic crown are innumerous, since the dentist will be unable to position it symmetrically on top of the implant. In such cases, generally the implant is positioned at a very inaccurate slant and consequently the main portion of the prosthetic crown (which imitates the tooth per se) needs to be quite distant from the place where it is fixed to the implant. The result is the occurrence of a leverage effect that will certainly shorten the useful life of the part to a considerable degree, generating constant treatment. Another drawback in such cases is the difficulty of brushing and cleaning due to the irregular shape of the crown, causing the precocious accumulation of bacterial plaque and its collateral consequences (bad breath, inflammation of the gum tissue with consequent bone loss and, finally, the short durability of the implant).

Even if the positioning of the implant is wrong to a lesser extent, in many cases it will still be required to cement the crown to the implant, which will prevent it from being removed without destroying it. Generally in such cases, the crown ends up assuming a shape that is hardly symmetrical in order to avoid that once it is installed it pressures the adjacent teeth too much, which would cause bone reabsorption (property of the alveolar bone to reabsorb material when something anchors onto it under pressure, so that the pressure ceases).

In other words, when a crown is installed under pressure against another tooth, it ends up forcing the implant and the bone portion at the site where the implant compresses the bone is reabsorbed, significantly decreasing its stability.

To-date, no guided surgery procedure has been developed to place an implant using devices such as enhanced guide tubes and guide tube positioners as a form of enabling a millimetric and real precision in boring orifices in bone tissue and positioning of the dental implant, avoiding all the drawbacks referred to above.

More specifically, thus far no guide tube has been developed that has considerably reduced the diversion and/or bending of the drill or bur when the bone tissue is bored, or a positioning device that has reduced and eliminated steps for the correct positioning of the guide on the plate made of polymeric material to be positioned on the jawbone or maxilla of the patient, also being extremely easy to use and simple to manufacture.

In short, although there are various types of guide tubes and their positioners on the market, thus far no guide tube or its respective positioning device has been created that presents effective constructive simplicity and low-cost manufacture, besides offering impeccable performance and easy manageability, and presenting possibility of large-scale application, enabling guided surgery to be performed on a truly millimetric basis, which is an unprecedented fact not yet achieved on a mass basis.

The object of the present invention is a guide tube, particularly idealized to bore orifices for dental implants, which concomitantly presents the converse characteristics of conceptual and productive simplicity, operational safety, ease of use, efficiency in positioning the burs/drills, avoiding diversion or bending thereof when boring the bone tissue, and low manufacturing cost, allowing the large-scale application of guided surgery procedures.

Another objective of the present invention is a guide tube positioning device, that is equally simple to manufacture, easy to operate, accurate and efficient and that has a low purchase cost. It enables the precise positioning of the present or of any guide tube already known in a polymeric plate or the like, to carry out guided surgery procedures with high precision.

### BRIEF SUMMARY OF THE INVENTION

The objectives of the present invention are achieved by a guide tube, particularly idealized to enable the boring of orifices in the bone portion of the maxilla or the jawbone of a patient, comprising at least a first, outer tube segment, having a first axial through aperture and at least a second inner tube segment, having at least a free end and a second axial through aperture, the second tube segment being inserted inside the first axial through aperture of the first tube segment, and an integrated axial prolongation is projected from the free end of the inner tube segment.

Additionally, the objectives of the present invention are achieved by a guide tube, particularly idealized to enable the boring of orifices in the bone portion of the maxilla or the jawbone of a patient, comprising at least a first, outer tube segment, having a first axial through aperture and at least a second inner tube segment, having a second axial through aperture, the second tube segment being inserted inside the first axial through aperture of the first tube segment:
the outer tube segment comprising at least a lateral through orifice;
the inner tube segment comprising at least a third radially slanted through aperture;

the lateral through orifice and the third radially slanted through aperture being axially aligned when the inner tube segment is inserted into the first axial through aperture of the outer tube segment in a given locking position.

Further, the objectives of the present invention are achieved by a guide tube, particularly idealized to enable the boring of orifices in the bone portion of the maxilla or the jawbone of a patient, comprising at least a first outer tube segment, having a first axial through aperture and at least a second inner tube segment, having a second axial through aperture, the second tube segment being inserted inside the first axial through aperture of the first tube segment, the second axial through aperture enabling the positioning and operation of at least a bur or drill:
the outer tube segment comprising at least a lateral through orifice;
the inner tube segment comprising at least a third radially slanted through aperture;

the lateral through orifice and the third radially slanted through aperture being axially aligned and enabling the lubrication and refrigeration of the bur positioned inside the second axial through aperture.

Additionally, the objectives of the present invention are achieved by a guide tube, particularly idealized to enable the boring of orifices in the bone portion of the maxilla or the jawbone of a patient, comprising at least a first outer tube segment, having a first axial through aperture and at least a second inner tube segment, having a second axial through aperture, the second tube segment being inserted inside the first axial through aperture of the first tube segment, the second axial through aperture enabling the positioning and operation of at least a bur or drill, the outer tube segment comprising at least a means for handling and positioning.

Finally, the objectives of the present invention are achieved by a guide tube positioning device, particularly idealized to enable the correct positioning of a guide tube on a plate, comprising at least a base to which at least a combination is associated for movement, the base comprising at least a means for associating a definitive radiographic or tomographic support.

### BRIEF DESCRIPTION OF THE DRAWINGS

The present invention will now be described in greater detail based on a sample embodiment represented in the drawings. The drawings show:

FIG. 1—is a perspective view of the outer tube segment of the guide tube that is the object of the present invention.

FIG. 2—is a cut side view of a first embodiment of the inner tube segment of the guide tube that is the object of the present invention.

FIG. 3—is an upper view of the inner tube illustrated in FIG. 2.

FIG. 4—is a cut side view of a first embodiment of the guide tube that is the object of the present invention, in operating position.

FIG. 5—is a cut side view of a second embodiment of the inner tube of the guide tube that is the object of the present invention.

FIG. 6—is a cut side view of a second embodiment of the guide tube that is the object of the present invention, in operating position.

FIG. 7—is a cut side view of a third embodiment of the inner tube segment of the guide tube that is the object of the present invention.

FIG. 8—is a cut side view of a third embodiment of the guide tube that is the object of the present invention, in operating position.

FIG. 9—is a perspective view of the guide tube positioning device that is the object of the present invention.

FIG. 10—is a side view of the guide tube positioning device that is the object of the present invention.

FIG. 11—is a first partial view of the guide tube positioning device that is the object of the present invention.

FIG. 12—is a second partial view of the guide tube positioning device that is the object of the present invention.

FIG. 13—is a third partial view of the guide tube positioning device that is the object of the present invention.

FIG. 14—is a fourth partial view of the guide tube positioning device that is the object of the present invention.

FIG. 15—is a fifth partial view of the guide tube positioning device that is the object of the present invention.

FIG. 16—is a sixth partial view of the guide tube positioning device that is the object of the present invention.

FIG. 17—is a seventh partial view of the guide tube positioning device that is the object of the present invention.

FIG. 18—is an eighth partial view of the guide tube positioning device that is the object of the present invention.

FIG. 19—is a ninth partial view of the guide tube positioning device that is the object of the present invention.

FIG. 20—is a tenth partial view of the guide tube positioning device that is the object of the present invention.

### DETAILED DESCRIPTION OF THE DRAWINGS

The dental implant is commonly used to recover the appearance of the mouth of a patient who definitively lost one or more teeth.

As it is known, besides enabling the mastication and grinding of food into small portions (capable of passing through the esophagus), the teeth have other important functions, including the aesthetic appearance conferred to persons and also the influence they exert on certain speech phonemes, without which the pronunciation would be prejudiced. Hence, the presence of teeth in the mouth is very important.

Typically, the dental implant procedure comprises the use of a synthetic tooth (technically called a prosthetic crown) which should be positioned at the site of the missing original tooth, with a view to restoring the capacity of mastication and other properties attributed to the teeth, as described above.

The dental crown is fixed to an implant, which in turn is positioned inside an orifice bored into the bone portion of the maxilla (upper arcade) or the jawbone (lower arcade) of the patient's mouth.

The implant must be correctly and firmly fixed to the bone, such that the prosthetic crown becomes as stable as a natural tooth.

The conventional procedure of installing an implant, referred to as free-hand surgery, has already been commented upon and comprises the boring of the already mentioned orifice in the maxilla or jawbone of the patient, installation of the implant, and fixing of the prosthetic crown to the implant. A plurality of types of implant is used, such as for example, cylindrical or threaded implants.

In a more detailed description, the implants are normally made of titanium alloys (due to the low reactivity and the quick and reliable association with the bone tissue) and its upper portion comprises means for association to the prosthetic crown, such that the latter is correctly installed.

The boring of the bone tissue to fix the implant needs to be carried out at a correct distance from the adjacent tooth to guarantee the correct positioning of the prosthetic crown, both from an aesthetic and functional aspect. Therefore, the orifice needs to be such that it enables the correct anchoring of the implant in the bone. As mentioned above, the professional needs to consider a series of other variables to determine the correct positioning of the implant, such as profile and relief of the bone portion at the implant site, positioning of the maxillary sinus, the nasal cavity floor and the lower alveolar nerve, among others.

Therefore, although the matter of positioning the orifice is rather delicate, it is common for the professional to bore the orifice based solely on his own professional experience. However, in view of the limited space in the patient's mouth (rendering the professional's job difficult), it is decidedly hard and fallible to determine the correct position of the orifice and bore it without preliminary studies, or else try to perforate the bone tissue by free hand, even having performed preliminary studies on the correct positioning of the implant. Save rare exceptions, the site where the implant is positioned is very far from its planned site.

The present invention refers to a guide tube and a guide tube positioning device (which are described ahead) which enable implant installation guided surgery to be performed with millimetric precision in boring the orifice for positioning of the implant. The precision achieved by this technique is proved to be 0.3 millimeter (mm), but it may vary, evidently, without being out of the scope of the protection of the invention.

The present procedure begins with the exact determination of the positioning of the implant. Said determination is preferably carried out by analyzing the tomography examinations performed on the face of the patient, though it is also possible to determine the position by way of radiographic examinations combined with complementary gum drilling examinations, which will be explained further ahead.

When using tomography examinations (which is largely preferred due to the innumerous items of additional information it provides compared to radiography, not to mention its greater inherent precision), firstly the professional makes a plaster model of the patient's dental arcade and, based thereon, makes a plate made of polymeric material (usually acetate or PVC thermoplastic). This plate is widely known in the field of odontology, is easy to make and the cost is low, quite the opposite of the highly expensive plates obtained by the already mentioned prototyping process.

On this plate is installed a tomographic support that is the subject matter of the aforementioned and incorporated '______ Application in the name of the same applicants as this present application.

Essentially, this tomographic support comprises a body in a substantially inverted U-shape, defining a first main portion having two free ends from each of which a respective prolonged rectangular portion (which comprise the ‘legs’ of the U-shape) projects.

The first main portion and the two prolonged rectangular portions define a space that will be occupied by the mandibular or maxillary anatomic portion when the support is installed in the patient's mouth or in a mold corresponding to the dental arcade of this patient.

In a more detailed description, the first main portion comprises a first surface, facing the space defined and the second surface, opposite. Analogically, each of the prolonged rectangular portions comprises a first surface facing towards the defined space and a second surface, opposite.

Preferably, the prolonged rectangular projections have the same length and are substantially parallel in relation to one another and substantially perpendicular in relation to the main portion, but it is obvious that the geometric details may vary freely, not least because the anatomy of the maxilla and the jawbone varies enormously from one person to the next.

Also preferably, the second surface of the first main portion comprises one or more fitting elements that prevent the rotation of the guide tube positioning device when it is fixed to the support. Preferably, two rectangular projections are provided, being substantially transversal and positioned symmetrically and equidistantly from each other.

The tomographic support is installed on the plate, at the site where the tooth is missing, and a radiopaque element is placed there in the approximate shape of a tooth. Additionally, two vertical screws made of vertical radiopaque material, being parallel, having the same height, each positioned in one of the prolonged rectangular projections, are inserted into the tomographic support. It is important to emphasize that said projections have the same length and are substantially parallel in relation to one another and substantially perpendicular in relation to the main portion of the support.

The plate made of polymeric material containing the tomographic support with the two vertical screws and the radiopaque tooth is installed over the dental arcade of the patient and the face of the patient is scanned in the tomograph.

The images resulting from the tomograph, in the region in question, will show all the bone characteristics, the neighboring teeth, the radiopaque tooth (which, on examination, will have the appearance of a regular tooth, as if it were present), and the two vertical radiopaque screws present in the tomographic support, which are parallel in relation to one another and have the same height.

The professional can then command the computer program to cut the parallel and perpendicular images on the line determined by the two vertical radiopaque screws. Once the tomographic support has been positioned perpendicularly in relation to the acrylic plate, this condition is guaranteed and a series of geometrically precise images can be generated.

Since said images are perpendicular and parallel in relation to the bone, there is no deformation of the measures highlighted, and the planning of the positioning of the implant can be ideal.

Once in possession of the perpendicular and parallel images of the bone in the implant region, the professional can draw the ideal size and position of the implant on the images, based on the thickness of the bone tissue, positioning of the nerve, of the maxillary sinus or of the floor of the nasal cavity, the position of the neighboring teeth and also the ideal position of the tooth to be implanted (simulated by the radiopaque tooth installed on the tomographic support).

Based on the surgical planning, the computer program generates figures corresponding to the ideal positioning of the orifice, namely, the transversal position in relation to the bone (referred to as the vestibular-lingual distance), the transversal angle in relation to the bone (referred to as the vestibular-lingual angle), the longitudinal position in relation to the bone (referred to as the mesio-distal width), the longitudinal angle in relation to the bone (referred to as the mesio-distal angle) and its depth.

In possession of these figures, the ideal position for the orifice is formed, and the next step is to install the guide tube in the plate, in this exact planned position.

To install the guide tube, the polymeric plate is withdrawn from the patient's mouth and installed again on the plaster models. Next, the tooth and the two vertical radiopaque screws are withdrawn, leaving the two respective orifices.

Then, the guide tube positioning device 55 that is the object of the present invention, which will be described next, is screwed into one of the two orifices that received the vertical radiopaque screws.

Since the guide tube positioning device 55 is installed exactly in the same position occupied by a vertical radiopaque screw, the spatial reference on the plaster model is the same spatial reference as the tomographic examination, which makes images based on the positioning of the vertical radiopaque screws.

By way of handling its components, the guide tube positioning device 55 enables the installation of the guide tube on the acrylic plate, in the exact position of the orifice that is to be bored in the bone portion of the patient, regarding its positioning and vestibular-lingual and mesio-distal angles. After the correct positioning, the guide tube is fixed to the acrylic plate definitively.

Finally, the acrylic plate is installed into the mouth of the patient and the bur or drill positioned inside the guide tube is rotated, carrying out the perforation.

However, despite the extreme precision that this process confers in terms of the positioning of the guide tube, it alone is not guarantee of the effective precision of the drilling due to the already mentioned fact that the free cutting end of the tool tends to divert or bend during the work. Said imprecision will be avoided by the guide tube that is the object of the present invention, which will be described below.

In the event that it is not possible to use tomography examinations, it is possible to obtain a reasonable precision with the combination of radiographic examinations and complementary gum drilling examinations.

As mentioned previously, in the use of radiographic images, the professional has no way of knowing the exact depth and the relief of the bone portion at the implant site, and is also unaware of the precise location of the lower alveolar nerve in relation to the top of the bone edge. Therefore, to complement this information, and obtain the true contour of the bone portion where the implant is to be introduced, a gum drilling examination is performed, which usually comprises successive perforations at the gum sites, which enables the professional to map the transversal section of the bone. Once the information on gum depth has been gathered for each point, the professional is able to draw up a reasonably precise profile of the contour. To carry out this mapping procedure, the acrylic plate is usually punctured, creating a plurality of small orifices that enable said drilling to take place.

To guarantee that the puncture used to perforate the gums penetrates them perpendicularly, the present process uses the radiographic support described in the aforementioned '______ Application. The plate with this support is installed in the patient's mouth prior to carrying out the x-ray examinations.

The radiographic support comprises a plurality of tubular through orifices to enable transgengival perforation, slantedly and strategically positioned, so as to enable perforation in various point of the gums always in a perpendicular fashion so that the depth figure corresponds to the relative gum thickness. Failing to perforate I a perpendicular fashion would cause an imprecise and therefore failed mapping.

The support also comprises a first radiopaque body and a second radiopaque body that permits the correct visualization of the support when taking the x-ray plates. Deformation of the image generate by radiography would lead to a deformation of the shape of the radiopaque body, which can be measured. Having obtained the deformation value of the radiopaque body, it is possible to determine, by inverse calculation, the real bone measurements in a reasonably precise manner.

Having obtained the values for radiograph and gum perforation, the professional can calculate the correct positioning of the implant, and the depth of the orifice should not exceed the distance between the top of the edge and the noble structure, be it the nose cavity, the maxillary sinus or the lower alveolar nerve.

The rest of the process is the same, that is, the guide tube positioning device is installed over the radiographic support and manipulated until the guide tube is correctly positioned, and the guide tube is then fixed to the acrylic plate.

The guide tube that is the object of the present invention collaborates to bore the orifices in the correct position, since it presents characteristics such as simplicity and easy handling and operation, notably concerning the facility of positioning, and also avoids the problem that the perforating end of the bur or drill, after passing through the guide, diverts or bends while it sustains the load of having to perforate the bone, and thereby enormously increases the final precision of the orifice. Additionally, the guide tube is simple, easy to manufacture and has a low purchase cost, which factors favor its use on a large scale.

In essence, the guide tube that is the object of the present invention comprises at least a first outer tube segment 1 having a first axial through aperture 5 and at least a second inner tube segment 2 having a second axial through aperture 6, the second tube segment 2 being inserted inside the first axial through aperture 5 of the first tube segment 1.

It is the outer tube segment 1 that is fixed on the acrylic plate after having been correctly positioned by the positioning device 55, such as described previously.

The inner tube segment 2, in turn, is also known as a reduction tube, because it snugly adjusts to the diameter of the bur or drill, which is inferior.

It is important that the inner diameter of the first axial through aperture 5 be substantially equivalent to the outer diameter of the second tube segment 2. If there is an excessive clearance between the tube segments, the second tube segment 2 may present a radial slack inside the first aperture 5, which will make execution of the orifice in the bone of the patient more imprecise. Moreover, in a situation in which the second tube segment 2 enters with too much interference inside the first aperture 5, the functionality is prejudiced, because it will be necessary to apply substantial force.

Preferably, both outer and inner tube segments 1, 2 present circular transversal sections, although in certain specific circumstances other cross-sectional shapes may be used.

The outer tube segment 1 also comprises at least one lateral through orifice 3, substantially cooperative with at least one respective third through aperture 7 provided in the inner tube segment 2, as can be seen in the drawings.

When the inner tube segment 2 is inserted inside the first axial through aperture 5 of the tube segment interior 1, in a locking position, the lateral through orifice 3 and the third through aperture 7, which is radially slanted, become axially aligned.

The so-called locking position is that where there is no angular movement of the inner tube segment 2 in relation to the outer tube segment 1, and corresponds to the working situation of the guide tube, to be explained below. Alternatively, there may be a configurative variation of the present guide tube where a slight angular movement is provided, as long as this movement does not completely skew the side through orifice 3 and the third through aperture 7.

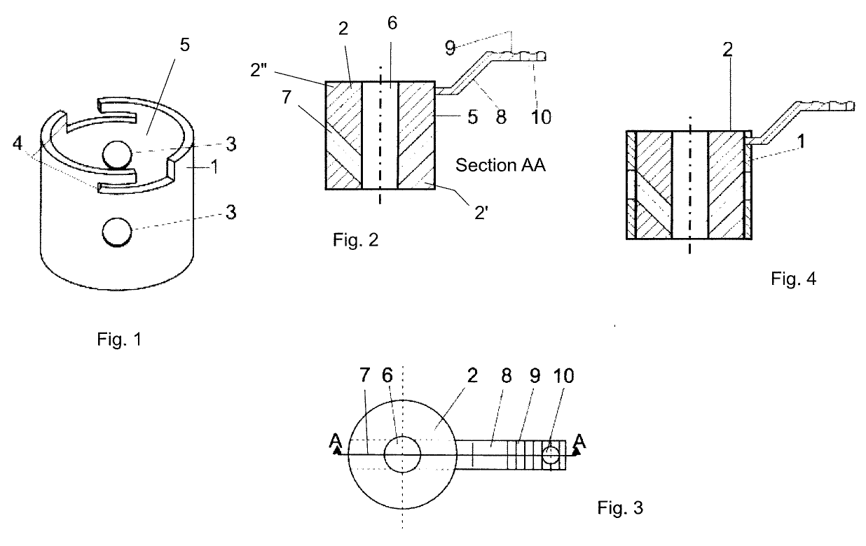

Also preferably, the outer tube segment 1 comprises two lateral through orifices 3 positioned on its median line and diametrally opposite, as illustrated in FIG. 1, although this is just one of the many possible variations.

In the preferred case, in order to cooperate with the two lateral through orifices 3 positioned medially and diametrally opposite, the inner tube segment 2 comprises two third through apertures 7 diametrally opposite, each having a first end portion positioned on the median line of the outer wall of the inner tube segment 2.

Preferably, the third through apertures are downwardly slanted, that is, each comprises a second end portion positioned in the lower portion of the wall that defines the second axial through aperture 6.

It is important to reiterate that the shape, geometry, positioning, and quantity of through orifices 3 and third through apertures 7 may vary freely without excluding the resulting guide tube from the scope of the appended claims.

Another characteristic of the guide tube that is the object of the present invention lies in the fact that the outer tube segment 1 comprises at least a locking means that preferably, but not necessarily, assumes the shape of a slot with radial entry 4, located at its upper end portion. Obviously, other shapes and arrangements of the locking means can be provided, as long as they are functional.

More preferably, the outer tube segment comprises two slots with radial entry 4, diametrally opposite, such as illustrated in FIG. 1, though its specific shape may vary freely.

Another innovative feature of the guide tube that is the object of the present invention, and that especially facilitates its installation, use and operation, is the existence of at least a means of handling and positioning 8, which is preferably latch-shaped, substantially linear and slanted, that projects radially and upwardly from the outer wall of the outer tube segment 2. Obviously other variations can be used, if necessary or desirable.

Preferably, the latch 8 comprises an end surface having a through hole 10 and knurled surface finishing.

However, the shape of the latch, the quantity, the surface finishing, and various other characteristics may vary freely, without excluding the resulting invention from the scope of the claims.

To assemble the guide tube, the outer tube segment is installed and fixed on the plate made of polymeric material, a procedure that has been explained above. This outer segment is placed in the ideal position calculated so that the bone orifice is perfect, by means of the guide tube positioning device which is also the object of the present invention and is described in detail below.

Hence, the outer tube segment 1 is positioned over the exact site where the dental implant will be installed.

The outer tube segment 1 having been fixed, the next step is to place, install and fix the inner tube segment 2 inside the first axial through aperture 5. After having been inserted inside the aperture 5, the outer tube segment 2 is angularly rotated until the latch 8, or the like, penetrates into one of the slots 4. After this penetration, the movement ceases and, due to the shape of the slot 4, the latch is prevented from moving even in the opposite direction, unless an upward force is applied thereto.

Preferably, the slots 4 have a geometry such that the latch 8 only penetrates inside when the inner tube segment 2 is moved angularly clockwise. Said situation is preferred since the drills and burs that bore the bone orifice (not illustrated) also rotate clockwise, and the unintentional or accidental unlocking, simply cannot occur. Such situation, however, is merely optional.

Due to the preferred existence of two slots diametrally opposite and a single latch 8, the professional can choose into which of the two slots 4 he wishes to insert the locking means, which can be very convenient since the latch 8 has the additional function of facilitating the positioning of the inner tube segment.

Moreover, it is important to note that said orifice 10 existing in the latch 8 serves to tie a surgical wire in order to avoid swallowing or accidental inhaling of the inner tube segment 2 in the unlikely situation that it becomes dislodged and freed from its position inside the first through aperture 5.

Finally, the primary function of the knurling provided on the latch 8 is to facilitate gripping of the instrument by the professional to position it inside said aperture 5.

After correctly fixing the inner tube segment 2, as mentioned above (see FIG. 4), the bur or drill can be positioned inside the second axial through aperture 6. This bur, driven by a tool, then rotates and opens up an orifice in the bone tissue of the jawbone or maxilla of the patient.

However, to guarantee the success of the surgery, the bone orifice must be opened up in stages, such that its diameter increases gradually. Accordingly, the surgeon must use various inner tube segments 2, with second axial through apertures 6 having diameters gradually larger that correspond to the diameters of the bone perforation drills.

Thus, after boring the orifice with the first bur, the surgeon replaces the inner tube segment 2 with another whose axial through aperture 6 is larger in diameter and, by using a larger-diameter bur, the bone orifice is further widened. This process can be repeated as many times as needed, using as many progressively larger inner tube segments 2 and burs required to achieve the desired orifice size.

Owing to the fact that the through orifices 3 and third through apertures 7 are aligned, it is possible to lubricate and refrigerate the bur positioned inside the second axial through aperture 6, or any other possible use, which is not possible using the guide tubes from the current state of the art. Said through aperture 7 links the inside of the aperture axial 6 to the outside environment. In the absence of lubrication, the drill or bur overheats and may burn the bone tissue inside the orifice, causing subsequent necrosis. If such necrosis occurs, it will result in inflammation that will cause the loss of the implant.

The major advantages of the downwardly slanted positioning of the through apertures 7 lies in the fact that they enable the refrigeration of the tool at the final instant before it penetrates the bone, eliminating the chances of excessive heating.

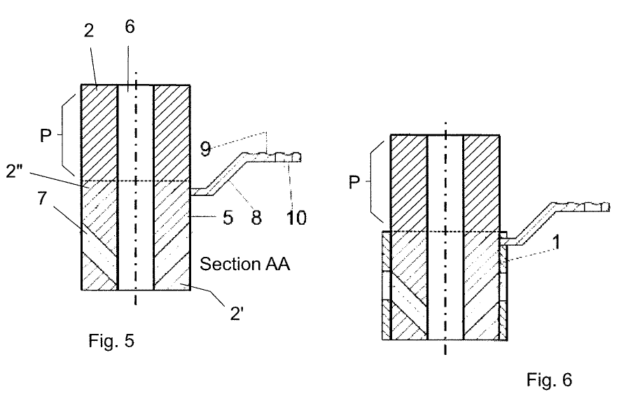

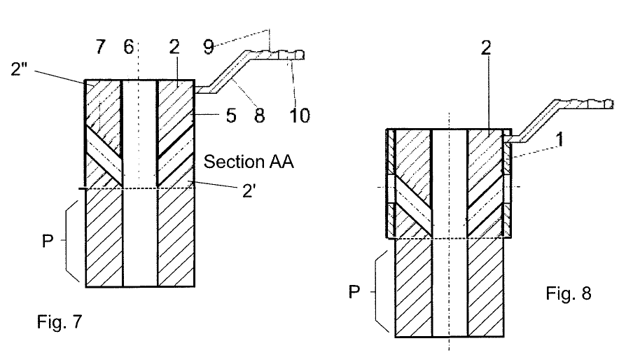

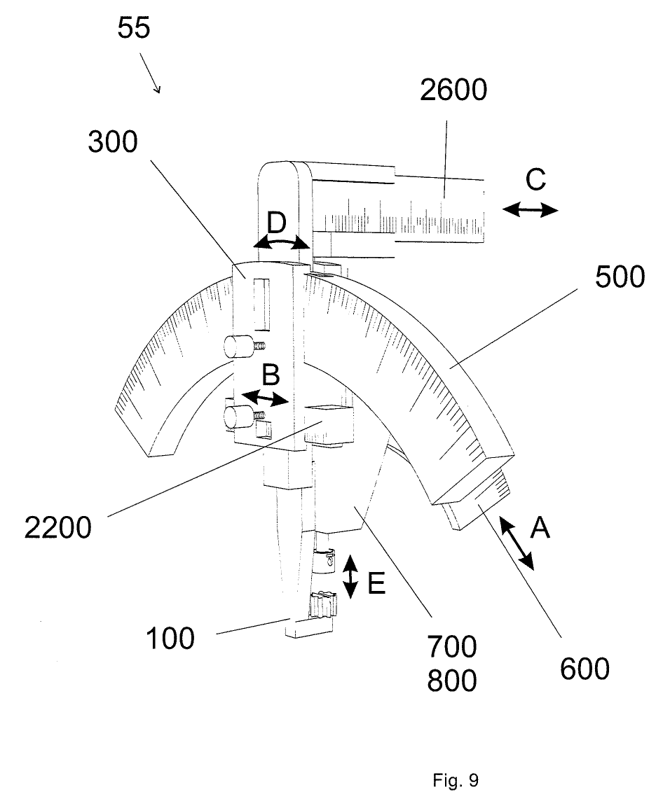

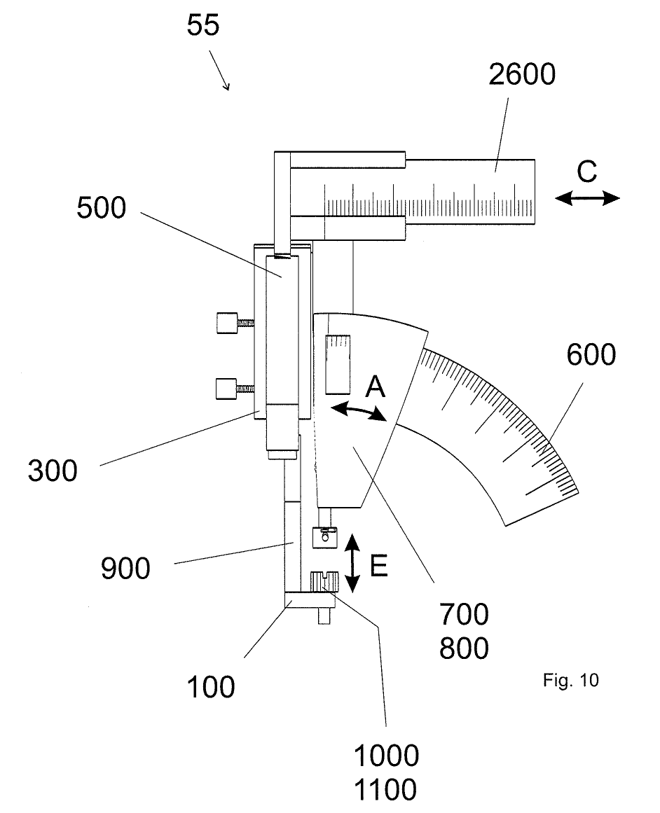

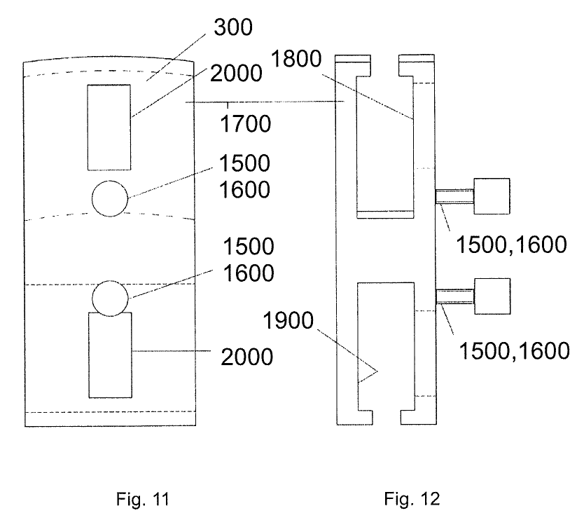

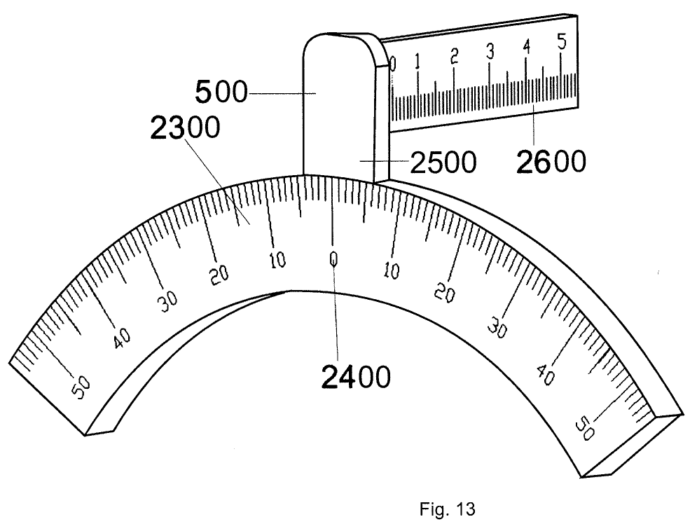

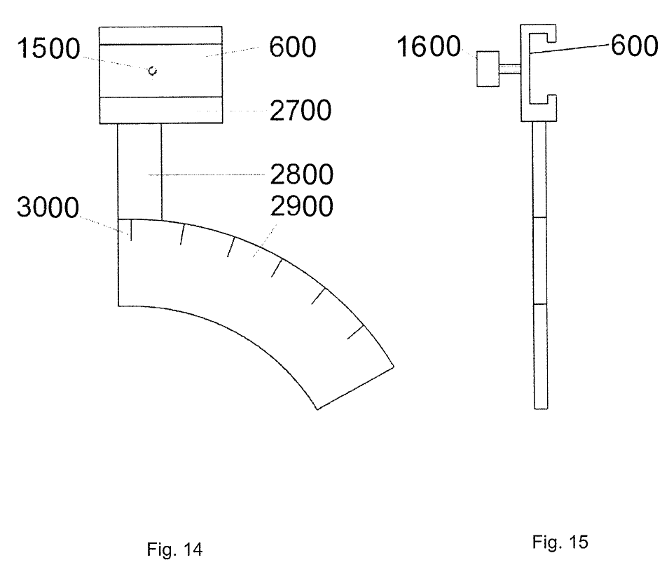

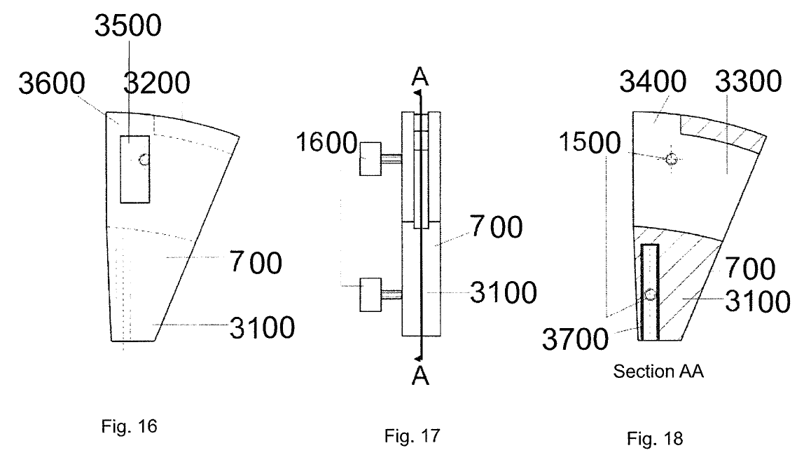

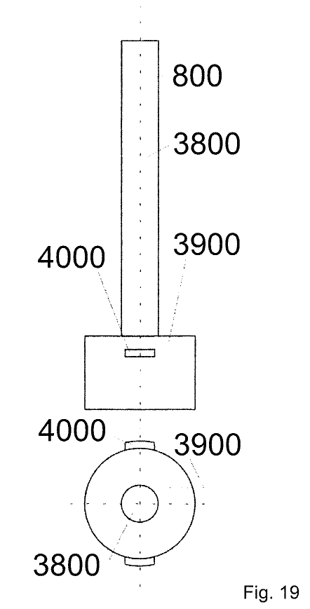

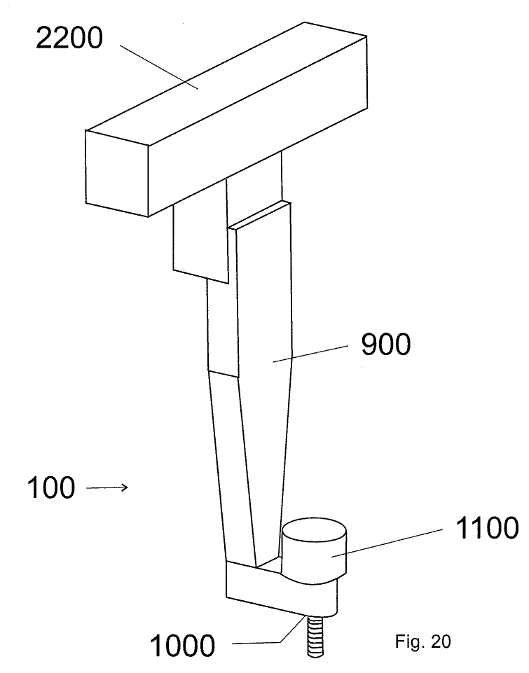

Notwithstanding the benefits referred to above, a further innovation of the guide tube that is the object of the present invention lies in the innovative constitution of the inner tube segment 2, which comprises an integrated axial prolongation P (FIGS. 5-8). This prolongation has the purpose of increasing the contact surface between the drill boring the bone and the inner aperture 6 of the inner tube 2 avoiding bending or diversion when the drill bores the orifice, particularly increasing the precision of the surgery.

In essence, the inner tube segment 2 comprises a first free end 2′ facing the bone portion, and an opposite second free end 2″.

In a first preferred variation of the invention, the integrated axial prolongation P projects from the second free end 2″, that is, it is opposite the bone (it is therefore facing the oral cavity of the patient). In a second preferred variation, the integrated axial prolongation P projects from the first free end 2′, that is, it is facing the bone. Each variation is preferred in a specific situation, to be described ahead.

In the case of the second variation, one possibility is that the integrated axial prolongation P has the same diameter as the rest of the inner tube segment, and another possibility is that it has a more reduced diameter.

The existence of the integrated axial prolongation P leads to a greater length of the inner tube segment 2, which confers greater stability of the drill or bur in its interior, as only a small portion of the tool will be free (without being constricted by the tube) when the orifice is being bored.

When the integrated axial prolongation P projects from the second free end 2″, it faces towards the oral cavity of the patient, which is a drawback when the implant to be placed is located at the back of the mouth (pre-molar and molar region, for example) due to the small opening of the oral cavity in this region.

However, if the implant is in the place of one of the incisor or canine teeth, this aperture limitation is rare and the axial prolongation P facing towards the mouth aperture allows a single-step boring of the orifice in the bone, with millimetric precision because of the absence of diversion or bending of the tool (which, over most of its length, is constrained by the inner tube segment 2).

To enable precise boring in the rear portion of the oral cavity, where the aperture is reduced, the variation of the inner tube segment whose axial prolongation P is facing towards the bone tissue is preferred.

In this situation, firstly an inner tube segment 2 without axial prolongation P is positioned inside the outer segment 1, and a first stage of partial boring is carried out. The depth of this first boring stage is reduced, in order to guarantee that only a small portion of the tool is free and that therefore there is no diversion or bending. This segment 2 does not include the axial prolongation P, so that it is not too high, and thus can be accommodated in the rear region of the oral cavity where there is a lack of space.

Once the first stage of partial boring is over, the segment 2 is withdrawn and in its place another segment 2 is inserted, however, having a short prolongation P (as a rule, the additional length of this prolongation in relation to that of the recently-withdrawn segment is equivalent to the depth of the orifice made in the first boring stage). This other segment 2 is positioned such that the free end of the prolongation P penetrates into the partially opened up orifice in the bone. As a result, the segment 2 is totally anchored in the bone and the diversion or bending of the drill are prevented. Also due to the penetration of the prolongation P into the orifice, the resulting height of this segment 2 in the oral cavity does not increase.

Next, the segment 2 is withdrawn and in its place another segment 2 is inserted, yet having a slightly longer prolongation P length. This other segment 2 is positioned such that the free end of prolongation P penetrates into the partially opened up orifice in the bone. This segment 2 is totally anchored to the bone and drill diversion or bending is prevented, and another segment of the orifice is bored. Also due to the penetration of the prolongation P into the orifice, the resulting height of this segment 2 in the oral cavity does not increase.

Depending on the depth of the orifice to be bored, it may be necessary to substitute this segment 2 and its substitution for another segment 2, whose prolongation P is longer to carry out a fourth boring stage, similar to the second and third stages.

Boring in stages, where an inner tube segment 2 is substituted for another whose prolongation P is longer, is referred to as staggered boring or burring, and the existence of various units, each having a prolongation P of a given length, is essential for the millimetric precision obtained at the end of the orifice drilling. Again, such precision is achieved only because of the innovative constitution of the inner tube segments 2 having prolongation P.

In short, the guide tube that is the object of the present invention, whose inner tube segment 2 has a prolongation P, makes it feasible to increase the contact surface with the drill/bur, increasing the precision of bone boring and, consequently, the final position of the implant.

The present invention also provides a guide tube positioning device 55 that enables the positioning of the guide tube with millimetric precision on a plate that is fixed firmly and precisely on the dental arcade of the patient.

The main characteristics of the positioning device 55 that is the object of the present invention are that it is easy to manufacture, easy to operate, precise and efficient, and has a low purchase cost, enabling the precise positioning of the present guide tube or of any already known guide tube on a polymeric plate or the like.

A preferred embodiment of the guide tube positioning device that is the object of the present invention is illustrated in the drawings and comprises at least a base 100 with which is associated at least a movement mechanism 300, 500, 600, described in further detail below. As an essential characteristic, the base 100 comprises at least a means 900, 1000, 1100 for association with tomographic or radiographic supports as described in the aforementioned '______ Application, the entire disclosure of which has been incorporated herein by reference.

The means for association with the radiographic or tomographic support preferably comprises a fixing support 900 having a through hole 1000 and a fixing element 1100, wherein the fixing support 900 is preferably an L-shaped bar and the fixing element 1100 is a screw having a thread, although such specific configurations may vary. Even more preferably, the screw 1100 is located at the front end of the fixing support 900.

A first horizontal graduated ruler 2200 is provided in the upper portion of the fixing support 900, and preferably has a thickness greater than that of the remainder of the fixing support.

The movement mechanism comprises at least a mesio-distal support 300, at least a mesio-distal goniometer and a vestibular-lingual track 500, at least a vestibular-lingual support and a vestibular-lingual goniometer 600, at least an assembler carrier 700 and at least a guide tube assembler 800.

The mesio-distal support 300 is fixed to the fixing support 900 and is comprised of a body preferably rectangular, vertical and upwardly curved 1700, having internally and transversally two through slots, a first upper slot 1800 and a second lower slot 1900. The upper slot 1800 has an upper aperture and describes the same outer curvature of the support 300, that is, its upper and lower surfaces are curved and have the same curvature radius. The lower slot 1900, in turn, has a lesser aperture.

The support 300 also comprises two open windows substantially rectangular, vertical 2000 on its forward face, having a first upper window and a second lower window. Between both windows are located two threaded holes 1500 housing screws 1600 or any other equivalently functional fixing means.

The mesio-distal goniometer support and vestibular-lingual track 500 is comprised of a graduated, circular-arched ruler 2300, the center of which 2400 is the vertical axis, and is fixed in its upper portion to a vertical support 2500 that also supports a second horizontal, graduated ruler 2600, perpendicular, in turn, to the end face of the graduated ruler 2300.

The vestibular-lingual support and vestibular-lingual goniometer 600 is comprised of a closed, horizontal U-shaped profile 2700, being open in its front portion and having a threaded hole 1500 in its rear face. Said threaded hole houses a manually-tightened screw or similar 1600.

The lower portion of the support 2700 is fixed to a vertical bar 2800 which, in turn, holds a semi-arched-shaped graduated ruler 2900, whose zero point 3000 is on the vertical plane.

The assembler carrier 700 is comprised of a substantially trapezoidal body 3100 whose upper face 3200 describes a curve, and having a substantially transversal inner arch-shaped slot 3300 that accompanies the curvature of the face 3200.

The carrier 700 also comprises a center-upper aperture 3400 of the slot 3300, a rectangular window 3500 on its front face 3600, two threaded orifices 1500 housing two manually-tightened screws 1600 and a substantially vertical tube 3700 embedded in its lower part.

The guide tube assembler 800 is comprised of a slender vertical axis 3800 fixed to a cylindrical basis having a wider diameter 3900, which in turn has two radial and horizontal teeth 4000 that are diametrally opposite.

When the device is assembled, the horizontal ruler 2200 of the base 900 is introduced into the lower slot 1900 of the support 300, fixed by the respective screw 1600.

In the upper slot 1800 a circular ruler 2300 is introduced, fixed by the respective screw 1600.

The horizontal ruler 2600 of the mesio-distal goniometer and vestibular-lingual track 500 is introduced into the profile 2700 of the vestibular-lingual support and vestibular-lingual goniometer 600.

The semicircular rule 2900 is introduced, in turn, into the inner slot 3400 of the carrier 700.

Finally, the vertical axis 3800 of the guide tube assembler 800 is introduced into the tube 3700 of the carrier 700, with the guide tube fitted on to its free end.

After this assembly, the screw 1100 is introduced into the orifice 1000 of the base 100 and screwed in a corresponding threaded orifice provided in the radiographic or tomographic support mentioned previously. Therefore, there is no base in the literal sense of the word. To assemble the device 55 onto the support, the latter must be associated to a polymeric plate and said plate, in turn, must be positioned on top of the plaster model. Additionally, the professional must already have the information regarding the positioning of the guide tube on the plate.

In the case of the tomographic support, since the threaded fixing orifice was occupied by the vertical radiopaque screw used in the tomographic examination, the simple positioning of the device 55 there already guarantees its precise position, and the perpendicularism in relation to the line formed by the two radiopaque supports, based on which the tomographic examination provided the various parallel and perpendicular cuts (already commented upon previously) guarantees that this positioning does not present any error or inaccuracy. And to prevent the device 55 from rotating in relation to the orifice, the already mentioned fitting elements are provided on the support.

After the physical description of the elements of the device positioned, there is a detailed explanation of its workings below.

Due to the constructive characteristics of the device 55, and as can be seen in the drawings, the vestibular-lingual goniometer only manages to position the guide tube at angles above zero, counted in relation to the plane defined by the fixing support 900. Accordingly, if we consider that the device 55 is positioned in one of the two orifices that received the vertical radiopaque screws, if the vestibular-lingual positioning angle of the guide tube is negative in relation to the plane defined by the support, it will be impossible to position it. In these cases, the device 55 should be installed in another orifice of the tomographic support, as it will be positioned at 180 degrees and it will be possible to position the vestibular-lingual angle correctly (because, operating otherwise, the vestibular-lingual angle will become positive compared to the reference (fixing support 900).

The angle is obtained from the movement of the assembler carrier 700 on the vestibular-lingual goniometer 600, illustrated in the drawings by the letter A. The angular movement can be controlled by observing the scale values of the vestibular-lingual goniometer 600.

Based thereon, the device should be handled to position the guide tube in the correct position. Considering the implant in a given tooth, from the position of the device 55 on the tomographic support (point zero), the respective elements of the movement combination should be handled for such.

In the case of the ideal position of the implant in deeper inside the mouth in the longitudinal sense (towards the throat), the professional moves the mesio-distal support 300 backwards (distal-wise) until the point deemed as ideal in its calculations. The movement distance can be controlled by up to one tenth of a millimeter based on the observation of values on the first horizontal ruler 2200.

In turn, if the ideal position of the implant is more outside the mouth in the longitudinal sense (towards the lips), the professional moves the mesio-distal support 300 forwards (mesial-wise) until the point deemed ideal in his calculations.

The mesio-distal movement can be seen in the drawings by the letter B.

Having defined the ideal position of the guide tube in the longitudinal sense, the professional now positions it transversally (towards the tongue—lingual—or towards the checks—vestibular).

As already mentioned, the positioning of the device 55 may vary according to the vestibular-lingual angle and the guide tube should be positioned.

Based on the positioning of the device 55, the vestibular-lingual support and vestibular-lingual goniometer 600 is moved slightly vestibular-wise or lingual-wise until the ideal transversal position is found. This movement is illustrated in the drawings by the letter C. The movement can be controlled by observing the values on the scale of the second horizontal graduated ruler 2600.

Having marked the mesio-distal position, the vestibular-lingual angle and the vestibular-lingual position, all that remains is to position correctly the tube in relation to the mesio-distal angle, which can be made by moving the vestibular-lingual support and vestibular-lingual goniometer 600 in relation to the mesio-distal goniometer 500. Since the track is curved, said movement generates a mesio-distal movement rotation of the goniometer 500. The angular movement can be controlled by observing the values on the scale of the mesio-distal goniometer 500 and is represented in the drawings by letter D.

Note that the device 55 is constituted with a geometry such that the radius center of both goniometers is precisely the point where it is fixed to the tomographic support.

Finally, the guide tube assembler 800 is lowered until it is positioned at the level of the acrylic plate, to which it is fixed. This movement is represented in drawings with the letter E. Next, the assembler 800 is hoisted and the guide tube remains fixed to the plate.

The assembly and operation for the case of the device 55 is fixed to the radiographic support is analog and, as a question of simplicity, will not be repeated.

Still preferably, each kind of linear movement (mesial, distal, vestibular and lingual) or angular (mesial, distal, vestibular and lingual) is easily identified with the application of colors on the respective numeric scales, which significantly facilitates the identification of the movement to be realized by those not particularly specialized in the art.

The device 55 presents innumerous benefits, including simplicity of manufacture and operation, precision, efficiency, low purchase cost, lightness, portability, absence of periodic maintenance, no need for specialized manpower for handling and the equipment is able to position the outer guide tube 1, both with information obtained from a tomography as well as information obtained from a radiography associated to gum drilling.

Due to its small size, the range of movements in which the guide tube is correctly positioned is small, making it more precision in operation and working.

However, obviously the constitution of the device may vary while still being included within the scope of protection of the invention. It is suffice that it comprises at least some element for movement with a view to the correct determination for the positioning of the first outer tube segment 1.

Alternatively, other embodiments of the device 1 can be provided for, such as for example that having an integrated base, wherein the plaster mold is positioned on this base and the equipment is calibrated such that the zero position is that where the orifice is located for the positioning of the radiopaque screw vertical.

Other more elaborate alternatives comprise a computer-controlled device, electrically moveable by means of stepping motors, in which the operator merely feeds the coordinates into the computer and all movements mentioned above for the correct positioning of the guide tube are made electrically.

Furthermore, any configuration can be proposed provided that it is functional.

Having described examples of preferred embodiments, it should be understood that the scope of the present invention encompasses other possible variations, and is limited only by the content of the appended claims, other possible equivalents being included therein.

What is claimed is:

1. A guide tube to enable boring of an orifice in a bone portion of a maxilla or jawbone of a patient, the guide tube comprising at least a first outer tube segment having a first axial through aperture, and at least a second inner tube segment having a first end facing towards the bone portion and an opposite second end, and having a second axial through aperture, the second tube segment being inserted inside the first axial through aperture of the first tube segment, wherein an integrated axial prolongation projects from one of the first and second ends of the inner tube segment.

2. A guide tube according to claim 1, wherein the integrated axial prolongation projects from the first end of the second tube segment facing towards the bone portion.

3. A guide tube according to claim 1, wherein the integrated axial prolongation projects from the second end of the second tube segment opposite the first end.

4. A guide tube according to claim 1, wherein the integrated axial prolongation enables the positioning of a drill or bur and prevents diversion or bending thereof when boring orifices in the bone portion of the maxilla or jawbone of the patient.

5. A guide tube according to claim 4, wherein the integrated axial prolongation fits into the hole made in the bone portion, anchoring the guide tube and preventing the diversion or bending of the drill or bur.

6. A guide tube to enable the boring of orifices in the bone portion of the maxilla or jawbone of a patient, comprising at least a first outer tube segment having a first axial through aperture and at least a second inner tube segment having a second axial through aperture, the second tube segment being inserted inside the first axial through aperture of the first tube segment, wherein:
the outer tube segment comprises at least a lateral through orifice;
the inner tube segment comprises at least a third through aperture that is radially slanted; and
the lateral through orifice and the third through aperture are axially aligned when the inner tube segment is inserted into the first axial through aperture of the outer tube segment in a given locking position.

7. A guide tube according to claim 6, wherein the outer tube segment comprises two medially located, lateral through orifices positioned diametrally opposite each other.

8. A guide tube according to claim 6, wherein the inner tube segment comprises two third through apertures diametrally opposite each other, each having a first end portion positioned on a median line of the outer wall of the inner tube segment and a second end portion positioned on the inner portion of the wall that defines the second axial through aperture.

9. A guide tube according to claim 6, wherein the outer tube segment comprises two slots with radial entry, diametrally opposite each other, located at an upper end portion of the outer tube segment.

10. A guide tube according to claim 6, comprising two or more inner tube segments.

11. A guide tube to enable boring of orifices in a bone portion of a maxilla or jawbone of a patient, comprising at least a first outer tube segment having a first axial through aperture and at least a second inner tube segment having a second axial through aperture, the second tube segment being inserted inside the first axial through aperture of the first tube segment, the second axial through aperture enabling the positioning and operation of at least a bur or drill, wherein:
the outer tube segment comprises at least one lateral through orifice;
the inner tube segment comprises at least one third through aperture radially slanted; and
the lateral through orifice and the third through aperture are axially aligned and enable the lubrication and refrigeration of the bur positioned inside the second axial through aperture.

12. A guide tube to enable boring of orifices in a bone portion of a maxilla or jawbone of a patient, comprising at least a first outer tube segment having a first axial through aperture and at least a second inner tube segment having a second axial through aperture, the second tube segment being inserted inside the first axial through aperture of the first tube segment, the second axial through aperture enabling the positioning and operation of at least a bur or drill, wherein the outer tube segment comprises at least one means of handling and positioning the outer tube segment.

13. A guide tube according to claim 12, wherein the means for handling and positioning comprises a latch which radially projects from the outer wall of the outer tube segment.

14. A guide tube according to claim 13, wherein the latch comprises an end surface having a through hole.

15. A guide tube according to claim 14, wherein the end surface of the latch has a knurled surface finishing.

16. A guide tube positioning device to enable the correct positioning of a guide tube on a plate, comprising at least a base to which at least a movement mechanism is associated, wherein the base comprises at least one means for associating to a definitive radiographic or tomographic support.

17. The guide tube positioning device according to claim 16, wherein the means for associating to a definitive radiographic or tomographic support comprises a fixing support having a through hole and a fixing element.

18. The guide tube positioning device according to claim 17, wherein the fixing support is an L-shaped bar and the fixing element is a screw having a thread.

19. The guide tube positioning device according to claim 16, wherein the movement mechanism comprises at least a mesio-distal support, at least a mesio-distal goniometer support and a vestibular-lingual track, at least a vestibular lingual support and a vestibular-lingual goniometer, at least an assembler carrier, and at least a guide tube assembler.
